(19) United States
(12) Patent Application Publication
(10) Pub. No.: US 2003/0173056 A1
(43) Pub. Date: Sep. 18, 2003

(54) Mass transit vehicle air distribution assembly

(76) Inventor: Alvin D. McCauley, Holly, MI (US)

Correspondence Address: REISING, ETHINGTON, BARNES, KISSELLE, P.C., P O BOX 4390, TROY, MI, 48099-4390, US

(21) Appl. No.: 10/388,135

(22) Filed: Mar. 13, 2003

Related U.S. Application Data
(60) Provisional application No. 60/363,863, filed on Mar. 13, 2002.

(51) Int. Cl. B60H 3/00

(52) U.S. Cl. 165/42

(57) ABSTRACT

An assembly for distributing air into the passenger compartment of a mass transit vehicle includes an elongated air distribution duct for installation in a cornice area of a vehicle passenger compartment. The duct guides conditioned air longitudinally along the cornice area and includes a vent positioned to direct conditioned air from the duct into the passenger compartment. The vent is shaped and positioned to direct air toward a longitudinal center aisle region of a vehicle passenger compartment that the assembly is installed in.

### CROSS-REFERENCES TO RELATED APPLICATIONS

This application claims priority from Provisional Application No. 60/363,863, filed Mar. 13, 2002, and entitled Mass Transit Vehicle Air Distribution Assembly.

### STATEMENT REGARDING FEDERALLY SPONSORED RESEARCH OR DEVELOPMENT

Not Applicable

### BACKGROUND OF THE INVENTION

1. Field of the Invention

This invention relates generally to a mass transit vehicle air distribution assembly for distributing air into the passenger compartment of a mass transit vehicle.

2. Description of the Related Art Including Information Disclosed Under 37 CFR 1.97 and 1.98

Mass transit vehicles include air distribution assemblies for supplying conditioned air into the passenger compartments of the mass transit vehicles. Such air distribution assemblies are known to include air ducts that run longitudinally along the ceiling and/or cornice areas of vehicle passenger compartments. The air ducts receive conditioned air from a source of conditioned air and distribute the air through vents into the passenger compartment.

To help mass transit vehicle manufacturers and their customers assess whether an air distribution assembly is capable of properly cooling the passenger compartment of a bus, a bus manufacturing association has established a standardized test known as “the Houston pull-down test” According to standard Houston pull-down test protocol, temperature probes are positioned at spaced locations along and 48″ above the floor of the center aisle of the bus. The bus is then heat soaked to 110 degrees Fahrenheit. To meet minimum standards, the air conditioning system must be able to bring down the temperature in the passenger compartment, as measured at the temperature test probes, to 78 degrees Fahrenheit, in no more than 30 minutes.

What is needed, therefore, is a mass transit vehicle air distribution assembly adapted to perform well according to the standards of the Houston pull-down test.

### BRIEF SUMMARY OF THE INVENTION

A mass transit vehicle air distribution assembly is provided for distributing air into the passenger compartment of a mass transit vehicle. The assembly includes an elongated air distribution duct configured to be installed in a cornice area of a vehicle passenger compartment. The elongated air distribution duct is configured to guide conditioned air longitudinally along the cornice area of the vehicle passenger compartment. The air distribution duct includes one or more vents positioned to direct conditioned air from the duct into the passenger compartment. Each vent is configured and positioned to direct air inboard toward a longitudinal center aisle region of a passenger compartment that the assembly is installed in. Therefore, a mass transit vehicle air distribution assembly constructed according to the invention is better able pass the Houston pull-down test.

According to another aspect of the invention, the mass transit air distribution assembly includes a second elongated air distribution duct configured to be installed in a cornice area of a vehicle passenger compartment opposite the first elongated air distribution duct. The second elongated air distribution duct includes at least one vent configured to discharge air into the passenger compartment from the cornice area. As with the vent of the first elongated air distribution duct, the vent of the second elongated air distribution duct is configured and positioned to direct air inboard toward the longitudinal centerline or aisle region of the bus, but from a laterally opposite direction. Being directed from laterally opposite directions, air streams flowing from the respective vents of the first and second elongated air distribution ducts impinge in the vicinity of the longitudinal center aisle region of the bus. This causes the two opposing air streams to mix turbulently with each other and with existing air thus speeding distribution of conditioned air throughout the passenger compartment.

According to another aspect of the invention, the vents are configured and positioned to direct respective air streams from the first and second ducts inboard to intersect at a point 48 inches above and centered on the aisle of a mass transit vehicle that the ducts are installed in. Since this point of intersection is located precisely at the position where temperature sensors are placed for the Houston pull-down test, directing the air streams in this way significantly improves the assembly's performance on the test.

According to another aspect of the invention, a light fixture is supported on and is installable with the air distribution duct.

According to another aspect of the invention, a plurality of the elongated air distribution ducts are supported end-to-end longitudinally along a vehicle passenger compartment cornice area to form a composite duct. The composite duct is configured to receive conditioned air at one intake along the composite duct and to direct the air longitudinally along the cornice area within the composite duct from the duct intake. As such, there's no need for a separate central duct to be included along a longitudinal centerline of the vehicle ceiling to provide longitudinal flow.

According to another aspect of the invention, the composite elongated air distribution duct is configured to receive conditioned air at a distal end of the composite duct and to direct the air longitudinally along the cornice area toward an opposite distal end of the composite duct.

According to another aspect of the invention, each duct includes an integral light fixture disposed longitudinally along a length of each duct.

According to another aspect of the invention, each duct includes a face panel hinged to swing open and allow access to an interior of the duct.

According to another aspect of the invention, the light fixture is supported on the face panel so that the light fixture can be installed with the assembly in a single step rather than two separate steps.

According to another aspect of the invention, the elongated air distribution duct includes a second set of vents disposed along and adjacent a lower edge of the duct. The vents are configured and positioned to discharge conditioned air downward over inner surfaces of windows disposed below and along the cornice area of the passenger compartment in side walls of the vehicle.

### BRIEF DESCRIPTION OF THE SEVERAL VIEWS OF THE DRAWINGS

These and other features and advantages of the invention will become apparent to those skilled in the art in connection with the following detailed description and drawings, in which:

FIG. 1 is a cross-sectional perspective view of a mass transit vehicle air distribution assembly constructed according to a first embodiment of the invention and installed in a mass transit vehicle passenger compartment;

FIG. 2 is a schematic cross-sectional view of the air distribution assembly and mass transit vehicle of FIG. 2;

FIG. 3 is a cross-sectional side view of a mass transit vehicle air distribution assembly constructed according to a first embodiment of the invention;

FIG. 4 is a cross-sectional side view of a mass transit vehicle air distribution assembly constructed according to a second embodiment of the invention;

FIG. 5 is a cross-sectional side view of a mass transit vehicle air distribution assembly constructed according to a third embodiment of the invention;

FIG. 6 is a cross-sectional side view of a mass transit vehicle air distribution assembly constructed according to a fourth embodiment of the invention and installed in a schematic representation of the cornice area of a mass transit vehicle passenger compartment, and

FIG. 7 is a cross-sectional side view of a mass transit vehicle air distribution assembly constructed according to a fifth embodiment of the invention.

### DETAILED DESCRIPTION OF INVENTION EMBODIMENT(S)

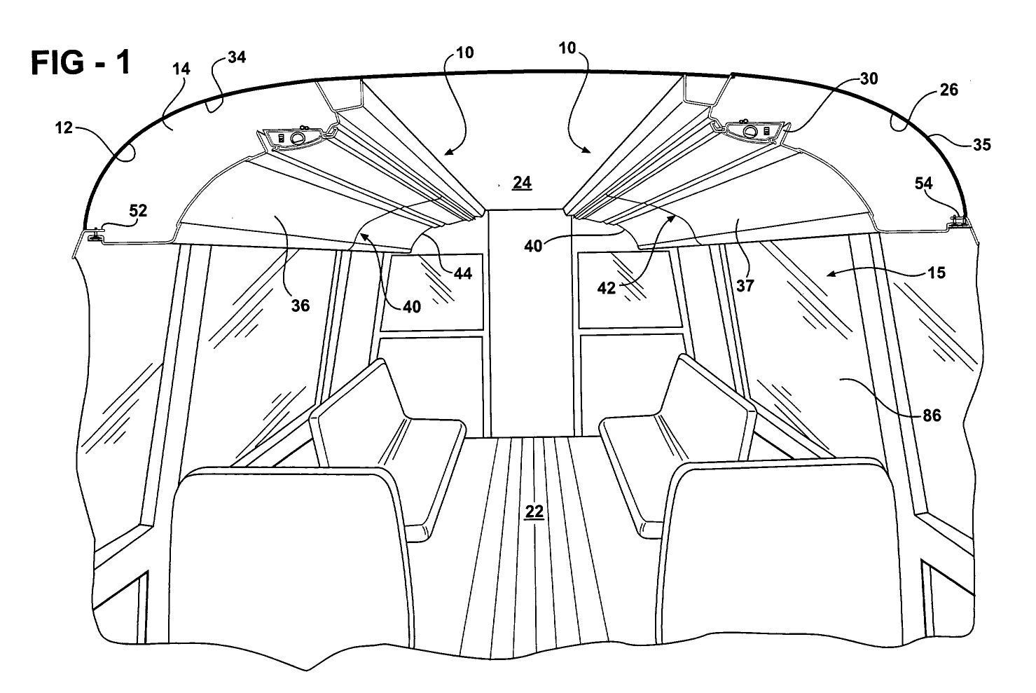

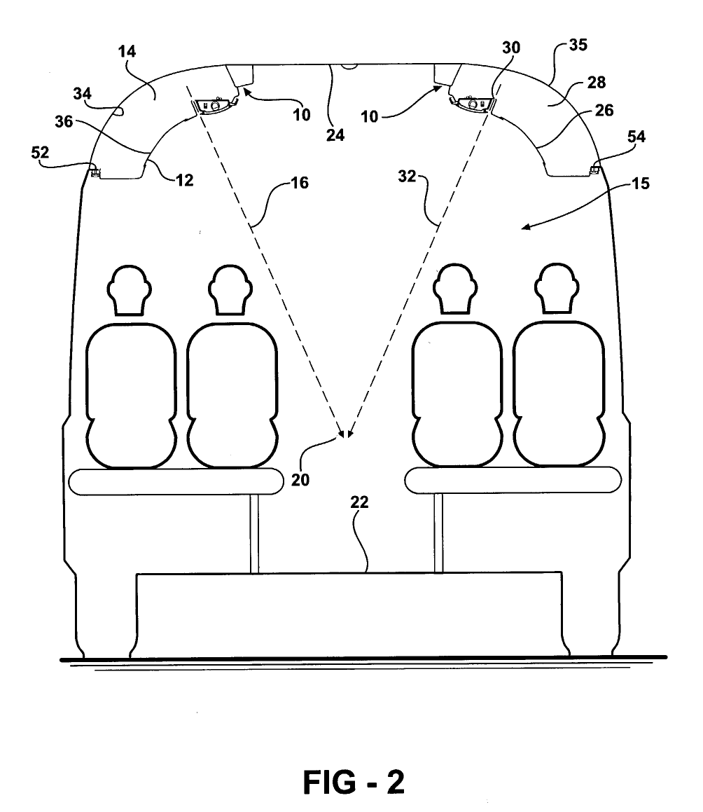

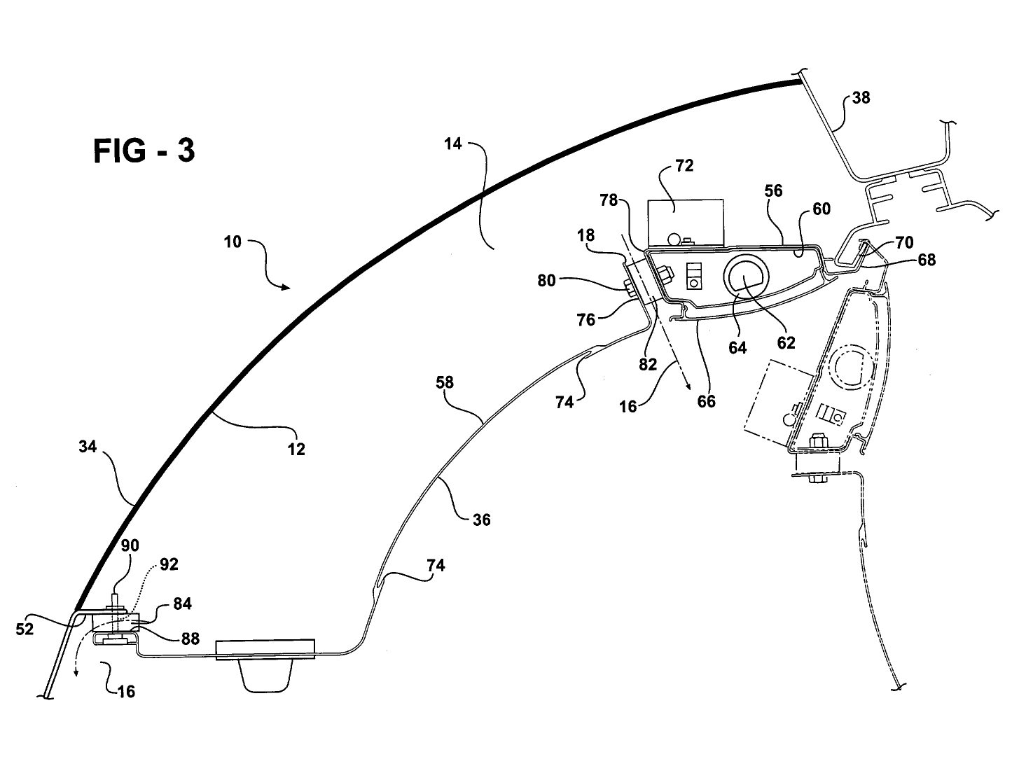

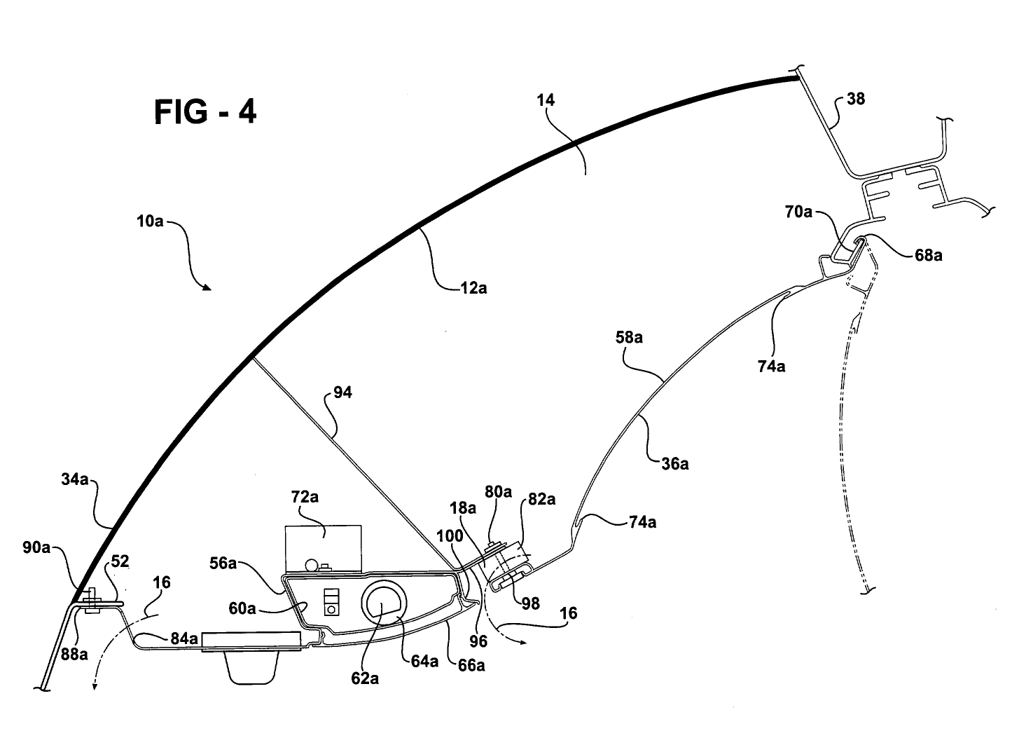

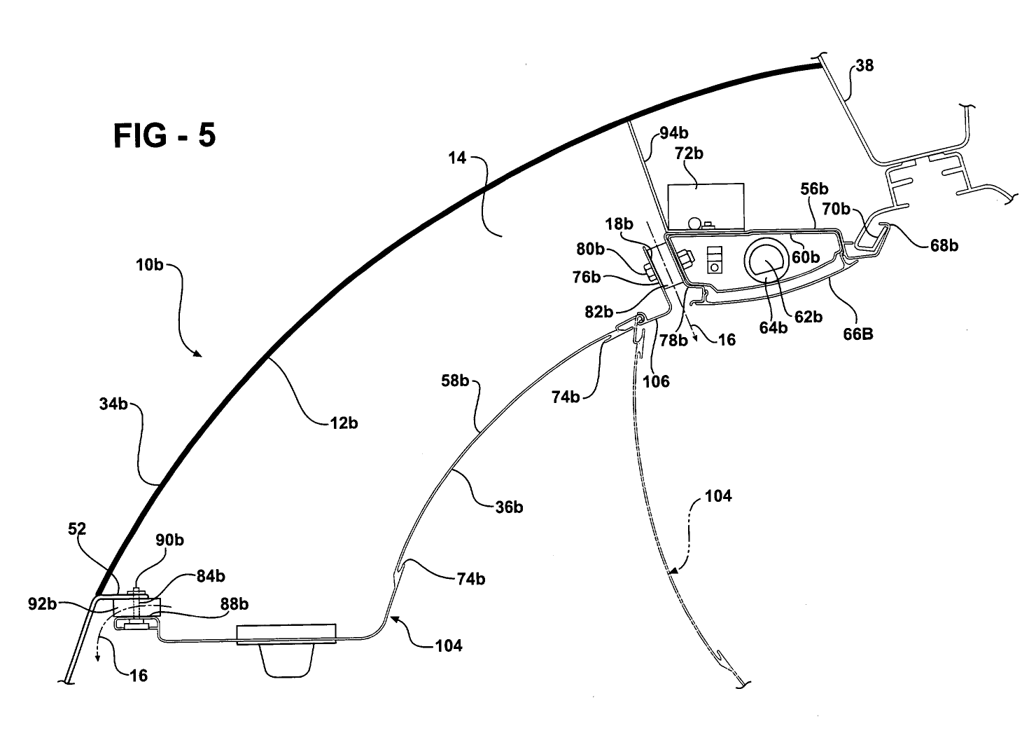

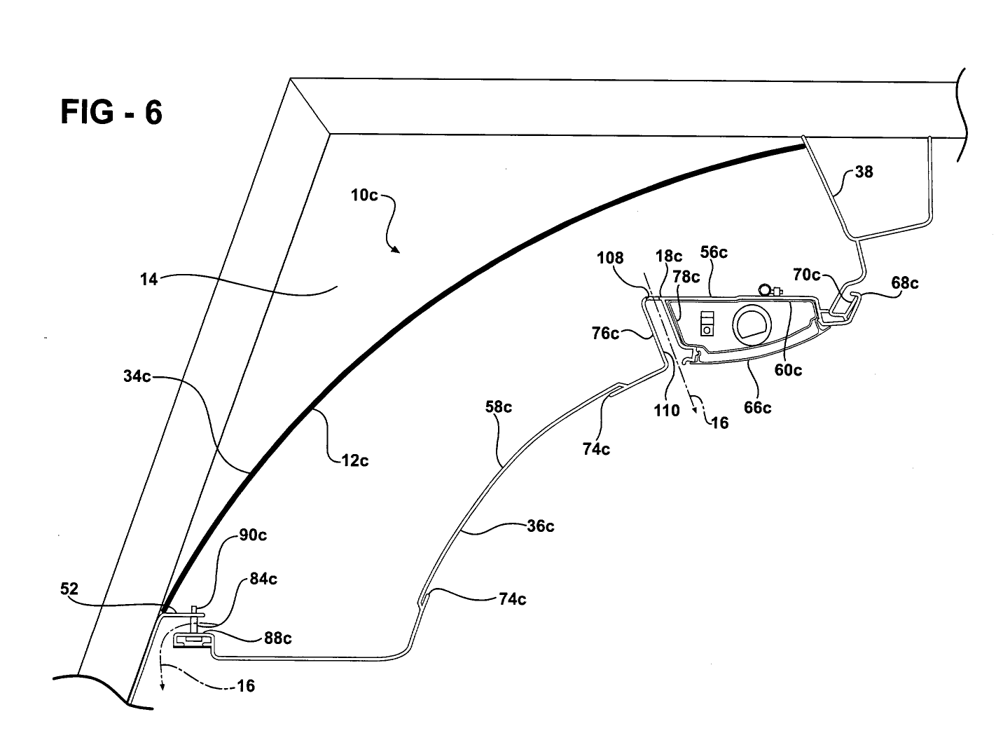

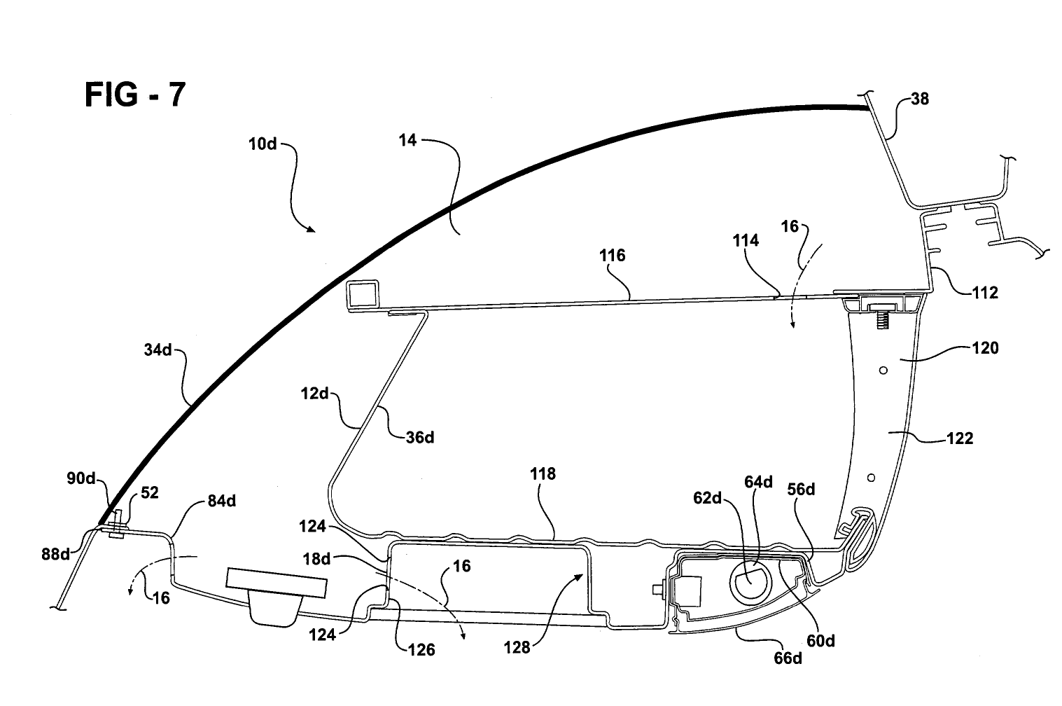

A first embodiment of a mass transit vehicle air distribution assembly for distributing air into the passenger compartment 15 of a mass transit vehicle is generally shown at 10 in FIGS. 1, 2, and 3. Second, third, fourth, and fifth embodiments are shown at 10a in FIG. 4, 10b in FIG. 5, 10c in FIG. 6, and 10d in FIG. 7, respectively. Reference numerals with the suffix “a” in FIG. 4, the suffix “b” in FIG. 5, the suffix “c” in FIG. 6, and the suffix “d” in FIG. 7 designate an alternative configuration of each element common to the embodiment of FIGS. 1, 2, and 3. Unless the description indicates otherwise, where the description uses a reference numeral to refer to an element in FIGS. 1, 2, or 3, we intend that portion of the description to apply equally to elements in FIGS. 4-7 that are indicated by the same reference numeral with the suffix “a”, “b”, “c”, or “d”, respectively.

In each embodiment, the assembly includes a first elongated air distribution duct 12 installed in a cornice area 14 of a vehicle passenger compartment 15. The first elongated air distribution duct 12 guides conditioned air 16 longitudinally along the cornice area 14 and includes a centrally-aimed vent 18 positioned to distribute conditioned air 16 from the duct 12 into the passenger compartment 15. The centrally-aimed vent 18 is shaped and positioned to direct air inboard toward a longitudinal centerline or aisle region 20 of the passenger compartment 15, the aisle region 20 being an area extending from an aisle floor 22 of the passenger compartment 15 to a ceiling 24 of the passenger compartment 15.

Also in each of the embodiments, a second elongated air distribution duct 26 is installed in a second cornice area 28 of a vehicle passenger compartment 15 dispose on a side of the aisle region 20 opposite the first elongated air distribution duct 12 as shown in FIGS. 1 and 2. The construction of the second duct 26 of each embodiment mirrors that of the first duct 12.

Like the first duct 12, the second elongated air distribution duct 26 includes at least one centrally-aimed vent 30 that discharges a stream 32 of air into the passenger compartment 15, but from the opposite cornice area 28 from the first duct 12. As with the centrally-aimed vent 18 of the first elongated air distribution duct 12, the centrally-aimed vent 30 of the second elongated air distribution duct 26 directs air toward the longitudinal centerline or aisle region 20 of the vehicle passenger compartment, but from a laterally opposite direction as best shown in FIG. 2. As such, the airflow streams 16, 32 from the respective centrally-aimed vents 18, 30 of the first and second elongated air distribution ducts 12, 26 impinge on one another in the vicinity of the longitudinal centerline or aisle region 20 of the passenger compartment. This causes the two opposing streams 16, 32 of conditioned air to mix turbulently with each other and with unconditioned air occupying the passenger compartment 15 in advance of the introduction of conditioned air 16, 32 from the air distribution assembly. This violent mixing speeds distribution of conditioned air 16, 32 throughout the passenger compartment 15. In other words, the centrally-aimed vent 30 of the second air distribution duct 26 discharges its air stream 32 in a direction that will cause that air stream 32 to cross and impinge on the air stream 16 discharged from the centrally-aimed vent 18 of the first duct 12. Preferably, the centrally-aimed vents 18, 30 direct air flow inboard from the first and second ducts 12, 26 to intersect at a point 48″ above and centered on the center aisle of a mass transit vehicle that the ducts are installed in—the same position as where temperature probes would be positioned in conducting a Houston pull-down test on the air conditioning system.

Each duct 12, 26 is approximately 6 feet long and, as shown in FIG. 4, is defined by a six foot long plastic back panel 34, 35 and a six foot long plastic front panel 36, 37. In other embodiments, the panels 34-37 may be formed from other suitable materials and the back panels 34, 35 may comprise a cornice wall of the vehicle the assembly is installed in. A portion of each duct 12, 26 is also defined by an existing elongated structure 38 that extends longitudinally along and downwardly from a ceiling of the host vehicle passenger compartment 15. The duct panels 34-37 are supported in and end-to-end abutting fashion along the length of either side of a host vehicle passenger compartment 15 to form composite ducts 40, 42 that run the length of either side of the passenger compartment 15 as shown in FIG. 1.

Each composite air distribution duct 40, 42 receives conditioned air at one intake 44, 46 along the length of each composite duct 40, 42 as shown in FIG. 1 and directs the air longitudinally along the cornice areas 14, 28 within the composite ducts 40, 42 from the duct intakes 44, 46. More specifically, the composite elongated air distribution ducts 40, 42 each receive conditioned air at a respective distal ends 44, 46 of the composite ducts 40, 42 and direct the air longitudinally along the cornice areas 14, 28 toward respective opposite distal ends 48, 50 of the composite duct 12 as shown in FIG. 1.

The back panels 34, 35 of each of the ducts 12, 26 are supported, at respective lower ends, on elongated, longitudinally disposed lips 52, 54 that extend inwardly from sidewalls of the host vehicle passenger compartment 15. Lower ends of the front panels 36, 37 are likewise supported on the inwardly extending lips 52, 54. Upper ends of the back panels 34, 35 are supported in a conventional manner to existing structural elements 38 of the host vehicle. Upper ends of the front panels 36, 37 are supported on lower edges of the existing host vehicle structures 38. The upper ends of the front panels 36, 37 are hinged to the lower edges of the existing host vehicle structures 38 and the lower ends of the front panels 36, 37 are releasably fastened to the lips 52, 54 to allow the lower ends of the front panels 36, 37 to be released and swung away from the lips 52, 54 to provide access to interior regions of the ducts 12, 26 for maintenance and cleaning.

Each front panel 36 is formed in two portions: a lamp retainer portion 56 and a card retainer portion 58, each of which is pultruded or extruded as a single unitary piece. The lamp retainer portion 56 of each front panel 36 is formed to include an elongated downwardly-opening channel 60 shaped to receive and retain lamp hardware 62, a lamp 64 and a lens 66 that closes the channel 60. The lamp retainer portion 56 also includes an elongated hook 68 shaped to hook over an elongated flange 70 along the lower edge of the existing host vehicle structure. A fluorescent lighting system ballast 72 can be supported on an upper surface of a back wall of the channel 60 below the back panel 34. The card retainer portion 58 of each front panel 36 is formed to include upper and lower slots 74 shaped to receive respective upper and lower edges of an advertising card.

Spaced-apart parallel horizontal vent walls define the centrally-aimed vent 18 of each assembly 10. One of the vent walls is an upstanding, upwardly-extending elongated flange 76 formed along an upper edge of the card retainer portion 58 of the front panel 36. The other of the vent 18 walls is a downwardly extending wall 78 of the elongated channel 60 of the lamp retainer portion 56 of the front panel 36. The two walls 76, 78 are held together by a four bolt-type fasteners 80 and spaced apart by four ¾ inch thick annular rubber grommets 82 that surround respective shafts of the four bolt-type fasteners 80. The fasteners 80 and grommets 82 are spaced approximately two feet apart.

Each air distribution duct 12 also includes a second set of vents 84, i.e., window vents 84 that are disposed along an adjacent a lower edge of each duct 12. The window vents 84 are configured and positioned to discharge conditioned air 16 downward over inner surfaces of windows 86 disposed below and along the cornice area 14 of the passenger compartment 15 in side walls of a vehicle the assembly 10 is installed in. As with the centrally-aimed vents 18, the window vents 84 are defined by spaced-apart parallel horizontal vent walls. One of the window vent walls is the elongated lip 52 extending from the sidewall of the passenger compartment 15. The other of the window vent walls is a lower edge region 88 of the card-receiver portion 58 of the front panel 36 that, when attached, is disposed parallel to the lip 52. As with the walls of the centrally-aimed vents 18, the two walls 52, 88 of the window vents 84 are held together by a four bolt-type fasteners 90 and spaced apart by four ¾ inch thick annular rubber grommets 92 that surround respective shafts of the four bolt-type fasteners 90. The fasteners 90 and grommets 92 are spaced approximately two feet apart. The bolt-type fasteners 90 used to hold the window vent walls together are preferably quarter-turn type fasteners that allow the front panel 36 to be disengaged from the lip 52 with only a quarter turn of a head of each of the four fasteners 90.

As shown in FIG. 4, according to the second embodiment, the lamp retainer portion 56a of the front panel 36a is fixed along an outer edge to the lip 52a and is releasably fastened along an inner edge to a lower edge of the card retainer portion 58a of the front panel 36a. An upper edge of the card retainer portion 58a of the front panel 36a is formed to pivotally connect to the lower edge of the existing host vehicle structure. A hanger strap 94 supports the inner edge of the lamp retainer portion 56a of the front panel 36a so that the card-receiver portion 58a of the front panel 36a can be released along its lower edge to be swung away to provide access to the interior of the duct 12a.

Also according to the second embodiment, one wall of the centrally-aimed vents 18a is an elongated flange 96 extending inwardly and upwardly from the lamp retainer channel 60a. The other wall is a lower edge region 98 of the card retainer portion 58a of the front panel 36a. Airflow is redirected toward the center aisle region 20 by an inner sidewall 100 of the lamp retainer channel 60a. The window vent arrangement of this embodiment, rather than being defined by parallel side walls, is instead an opening 84a or series of elongated openings formed adjacent and just inboard of the outer edge of the lamp retainer portion 56a of the front panel 36a where the outer edge of the lamp retainer portion 56a is fastened to the lip 52a.

As shown in FIG. 5, the third embodiment includes a hanger strap 94b that supports an outer edge of the lamp retainer portion 56b of the front panel 36b. The front panel 36b includes a main pivotal lower portion 104 that includes the card retainer portion 58b of the front panel 36b. The main pivotable lower portion 104 is pivotally attached to an elongated pivot mount portion 106. The pivot mount portion 106 includes the upstanding flange 76b that defines one wall of the centrally-aimed vent 18b and is rigidly fastened to and spaced from the lamp retainer portion 56b of the front panel 36b.

As shown in FIG. 6, the front panel 36c of the fourth embodiment is a single piece pultrusion or extrusion that includes both the lamp retainer portion 56c and the card retainer portion 58c. The centrally-aimed vents 18c of this embodiment are a series of elongated openings 108 formed into the upper end of a downwardly-opening elongated recess 110 formed alongside and immediately outboard of the lamp retainer channel 56c. The recess 110 is oriented to guide airstreams 16 emerging from the openings 108 toward the center aisle area 20 of the host vehicle passenger compartment 15.

As shown in FIG. 7, the fifth embodiment includes a combination luggage rack and light fixture assembly 10d. This luggage rack and light fixture assembly 20d is fastened along an upper edge to an elongated extrusion 112 that is, in turn, supported on a ceiling member 38 or other supporting structure of the host vehicle. A lower edge of the assembly is fastened along the lip 52 that extends inwardly from a sidewall of the host vehicle passenger compartment 15. The centrally-aimed vents 18d of this embodiment comprise openings 114 in an upper luggage compartment wall 116 of the assembly 10d. The luggage compartment 118 itself redirects air discharged through these upper wall openings 114 to exit the luggage compartment 118 toward the center aisle area 20 through large inwardly-facing luggage compartment access openings 120 defined between upright supporting stanchions 122 of the assembly 10d. The large access openings 120 are also configured to receive luggage to be stored in the luggage compartment 118. The centrally-aimed vents 18d also comprise openings 124 along an outer wall 126 of a downwardly-opening vent or accessory channel 128 of the assembly. The downwardly-opening vent channel 128 serves to redirect some of this air 16 downward toward a passenger seating area, but a significant portion of the conditioned air 16 continues to flow inward (inboard) toward the center aisle area 20. An elongated opening 130 or series of elongated openings 84d is or are formed adjacent and just inboard of the outer edge of the assembly 10d where the outer edge of the assembly 10d is fastened to the lip 52. These openings direct conditioned air 16 onto window surfaces of a host vehicle.

This description is intended to illustrate certain embodiments of the invention rather than to limit the invention. Therefore, it uses descriptive rather than limiting words. Obviously, it's possible to modify this invention from what the description teaches. Within the scope of the claims, one may practice the invention other than as described.

What's claimed is:

1. A mass transit vehicle air distribution assembly for distributing air into the passenger compartment of a mass transit vehicle, the assembly comprising:
a first elongated air distribution duct configured to be installed in a cornice area of a vehicle passenger compartment and to guide conditioned air longitudinally along the cornice area, the duct including a vent positioned to direct conditioned air from the duct into the passenger compartment; and
the vent being configured and positioned to direct air inboard toward a longitudinal center aisle region of a vehicle passenger compartment that the assembly is installed in.

2. A mass transit vehicle air distribution assembly as defined in claim 1 in which:
the assembly includes a second elongated air distribution duct configured to be installed in a cornice area of a vehicle passenger compartment opposite the first elongated air distribution duct;
the second elongated air distribution duct includes a vent configured to discharge air from the cornice area inboard toward the longitudinal center aisle region of the passenger compartment from a direction laterally opposite that of the first air distribution duct such that the air streams from the respective vents of the first and second elongated air distribution ducts impinge in the vicinity of the longitudinal center aisle region of the bus.

3. A mass transit vehicle air distribution assembly as defined in claim 2 in which the vents are configured and positioned to direct respective air streams inboard from the first and second ducts to intersect at a point 48″ above and centered on the aisle of a mass transit vehicle that the ducts are installed in.

4. A mass transit vehicle air distribution assembly as defined in claim 1 in which a light fixture supported on and installable with the air distribution duct.

5. A mass transit vehicle air distribution assembly as defined in claim 1 in which a plurality of the elongated air distribution ducts are supported end-to-end longitudinally along a vehicle passenger compartment cornice area to form a composite duct configured to receive conditioned air at one intake along the composite duct and to direct the air longitudinally along the cornice area within the composite duct from the duct intake.

6. A mass transit vehicle air distribution assembly as defined in claim 5 in which the composite elongated air distribution duct is configured to receive conditioned air at a distal end of the composite duct and to direct the air longitudinally along the cornice area toward an opposite distal end of the composite duct.

7. A mass transit vehicle air distribution assembly as defined in claim 5 in which each duct includes an integral light fixture disposed longitudinally along a length of each duct.

8. A mass transit vehicle air distribution assembly as defined in claim 1 in which the first duct includes a face panel hinged to swing open and allow access to an interior of the duct.

9. A mass transit vehicle air distribution assembly as defined in claim 8 in which the light fixture is supported on the face panel.

10. A mass transit vehicle air distribution assembly as defined in claim 1 in which the elongated air distribution duct includes a second set of vents disposed along and adjacent a lower edge of the duct. The vents are configured and positioned to discharge conditioned air downward over inner surfaces of windows disposed below and along the cornice area of the passenger compartment in side walls of the vehicle.
